(19) United States
(12) Patent Application Publication
(10) Pub. No.: US 2026/0225878 A1
(43) Pub. Date: Aug. 6, 2026

(54) Quantum-Controlled System for Hydrogen Extraction via Floquet-Engineered Bond Destabilization and AI-Regulated Reinjection Cycle

(71) Applicant: David Compton, South Miami, FL (US)

(72) Inventor: David Compton, South Miami, FL (US)

(73) Assignee: Bible 24 Foundation, Dover, DE (US)

(21) Appl. No.: 19/239,876

(22) Filed: Jun. 16, 2025

Related U.S. Application Data
(60) Provisional application No. 63/752,726, filed on Feb. 1, 2025.
(60) Provisional application No. 63/753,440, filed on Feb. 3, 2025.

(51) Int. Cl. C01B 3/042; B01J 19/00; B01J 19/12

(52) U.S. Cl. CPC C01B 3/042; B01J 19/0013; B01J 19/0033; B01J 19/121; B01J 2219/002; B01J 2219/0801; B01J 2219/0869; B01J 2219/0875

(57) ABSTRACT

A hydrogen production system utilizes Floquet-engineered photonic excitation and at least one dielectric laser excitation unit, including an Ava-assisted dielectric laser amplifier accelerator (AADLAA), under integrated quantum AI control. The system employs a multi-chamber architecture comprising a first dissociation chamber, a second dissociation chamber for partially processed effluent, and a purification and reinjection chamber. Catalyst-free water dissociation is achieved using synchronized laser modulation, AI-directed routing, and adaptive feedback. An AI-regulated safety network provides photonic alignment control, thermal and pressure management, gas purity safeguards, predictive hazard modeling, and fail-safe isolation. A thermal recovery module captures heat from one or more chambers for feedwater preheating and energy stabilization. The modular architecture supports upgrades in optics, safety, and energy inputs, including solar thermal, nuclear waste-heat, and geothermal sources. Purified hydrogen, oxygen, and water vapor are recovered, compressed, and selectively reinjected for closed-loop operation, achieving high efficiency with reduced entropy loss.

### CROSS-REFERENCE TO RELATED APPLICATIONS

This application claims priority to:

U.S. Provisional Application No. 63/752,726 filed Feb. 1, 2025, titled “Laser-Gated Floquet-Driven Hydrogen Extraction System Utilizing Polariton Charge Redistribution”;

U.S. Provisional Application No. 63/753,440 filed Feb. 3, 2025, titled “Floquet-Engineered Nuclear Hydrogen Production System.”

U.S. Provisional Application No. 63/747,085 filed Jan. 20, 2025, titled “Adaptive Multi-Fuel Engine Control System Integrating Carbon-Based Fuels and Hydrogen with Dynamic Optimization.”

U.S. Provisional Application No. 63/734,051 filed Jan. 14, 2024, titled “integrated Engine Optimization System Combining Pre Oiling, Thermoelectric Cooling, Laser Ignition, and Oxygen Enrichment

The entire disclosures of the above-referenced applications are incorporated herein by reference.

### SPECIFICATION SUPPORT STATEMENT

The present application claims priority to U.S. Provisional Applications 63/752,726 (Feb. 1, 2025), 63/753,440 (Feb. 3, 2025), and 63/747,085 (Jan. 20, 2025), each of which is incorporated herein by reference. The subject matter disclosed herein, does not introduce new matter, but represents exemplary implementations of the principles disclosed in those provisional filings.

Specifically, Provisional 63/752,726 discloses laser-gated Floquet excitation of O—H bonds, feedback-controlled pulse sequencing, and continuous dissociation cycles. Provisional 63/753,440 discloses nuclear thermolysis integration, multi-chamber scaling, purification, and safety systems (over-excitation, temperature, and pressure safeguards). Provisional 63/747,085 discloses adaptive ECM governance, modular retrofitting, continual diagnostics, waste-heat recovery, and hydrogen engine integration.

The present disclosure simply specifies embodiments consistent with those genera, including dielectric laser accelerator/amplifier hardware (AADLAA), Ava as the integrated AI controller, reinjection protocols as embodiments of continuous cycling, predictive hazard modeling as a refinement of disclosed safety, and modular photonic architectures as embodiments of scalable modularity. Each amendment remains fully supported by the priority applications and does not add new subject matter under 35 U.S.C. § 132(a).

### FEDERALLY SPONSORED RESEARCH OR DEVELOPMENT

Not applicable.

### Statement Regarding Micro Entity Status

Applicant hereby claims micro entity status under 37 CFR 1.29 and submits payment of the applicable USPTO government fees at the micro entity rate.

### Specification Clarification of Ava As Governing Control Core

As used throughout this specification and the appended claims, “Ava” denotes the system's integrated quantum AI core. Ava is not an external supervisory module but an embedded architectural governor and unifying control framework of the invention itself.

Ava continuously perceives the system state through a distributed network of embedded sensors, including spectrothermal probes, gas composition analyzers, pressure and temperature monitors, laser pulse feedback detectors, electrical sensors, and thermal recovery monitors. These reports form the system's sensory fabric, enabling real-time awareness of chamber dynamics, excitation conditions, gas purity, and safety thresholds.

Leveraging quantum machine learning and adaptive modeling, Ava governs all operational domains: photonic excitation sequencing, reinjection and compression cycles, purification routing, thermal recovery, and multi-layered safety protocols. Through this integration, Ava transforms the platform into a unified, adaptive intelligence that dynamically optimizes dissociation yield, gas purity, thermal balance, and operational stability across photonic, thermal, and chemical domains.

In certain embodiments, should Ava become impaired or unavailable, the system defaults to a safeguarded baseline mode. In this mode, independent hardware governors and redundant safety circuits sustain dissociation, purification, and compression functions at reduced efficiency but with full safety guarantees. Thus, while Ava enables the novel unifying intelligence that maximizes yield and adaptive control, the underlying system remains operable and inherently failsafe.

### Field Of The Invention

The present invention relates generally to hydrogen production and water purification systems, and more particularly to methods, apparatus, and platforms for extracting hydrogen from water using advanced photonic excitation and artificial intelligence-based control.

### Background of the Prior Art

Hydrogen is widely recognized as a versatile energy carrier, yet existing production methods such as electrolysis, steam methane reforming, and thermal cracking typically require substantial energy input and often depend on catalysts. These processes may also produce unwanted byproducts, lack real-time adaptability, or operate with reduced efficiency under variable conditions.

Many current systems further do not incorporate integrated feedback control, limiting their ability to dynamically adjust dissociation conditions or recover useful energy. As a result, such methods may exhibit higher entropy losses, lower overall yield, and increased operating costs.

Accordingly, there remains a need for improved hydrogen production systems that can operate catalyst-free, adaptively optimize dissociation and purification cycles, recover and reinject useful fractions, and integrate advanced control mechanisms to achieve higher efficiency, stability, and scalability across diverse operating environments.

### SUMMARY OF THE INVENTION

The present invention relates to systems, methods, and platforms for producing hydrogen through catalyst-free water dissociation using advanced photonic excitation and artificial intelligence (AI) control. In preferred embodiments, the system employs a multi-chamber architecture including a first dissociation chamber configured to apply Floquet-engineered photonic excitation, a second dissociation chamber that receives partially processed effluent and applies dielectric laser excitation for bond completion, and a purification and reinjection chamber that purifies product gases and vapors, selectively reinjects fractions, and compresses purified hydrogen for storage or distribution. Dissociation efficiency and stability are enhanced by an integrated quantum AI controller (Ava) that governs excitation timing, chamber coordination, purification, reinjection, thermal recovery, and layered safety functions in real time.

Unlike conventional electrolysis and thermochemical processes, which often operate below 80% efficiency, the present invention provides a dual-excitation, AI-governed system engineered to exceed conventional efficiency benchmarks. Bond destabilization is achieved by tuning excitation to molecular vibrational resonances through Floquet modulation, reinforced by dielectric-laser excitation from a dielectric-laser accelerator, dielectric-laser amplifier, or an Ava-assisted dielectric-laser amplifier-accelerator (AADLAA). In preferred embodiments, the Floquet field is phase-gated at the bond's outer turning point and frequency-matched to the O—H stretching mode, thereby enhancing field-molecule coupling and inducing transient, field-induced (Stark-like) polarization that promotes dissociation. In some embodiments, a first beam distributes Floquet excitation across multiple chambers while a second beam provides dielectric excitation; the beams may operate in parallel (simultaneous and phase-synchronized) or sequential (temporally offset) modes, and may be aligned collinearly or converge non-collinearly within a common interaction region. Ava dynamically synthesizes and updates control parameters—pulse timing, amplitude, wavelength, duty cycle, and phase—during operation using sensor feedback, while hardware-timed electro-optic and pulse-shaping modulators enforce picosecond-to-nanosecond gating with femtosecond-level pulse shaping at the interaction region. “The modular control stack includes standardized interfaces that support plug-and-play timing hardware and compute accelerators, thereby reducing enforcement latency and increasing re-optimization cadence as technology advances, without modification to the reaction hardware.”The system further employs AI-controlled purification and reinjection to achieve closed-loop stability. Only fractions that enhance purity, stabilize thermodynamics, or improve dissociation kinetics are reinjected, while undesired byproducts are isolated. A purification and reinjection chamber separates hydrogen, oxygen, and water vapor, directing fractions for compression, reinjection, or storage. In certain embodiments, purified hydrogen may be reinjected to serve as a kinetic buffer or routed to an adaptive hydrogen engine control platform for downstream combustion, ignition, cooling, or hybrid fueling. Ava continuously monitors sensor feedback from spectrothermal, photonic, chemical, and thermal detectors, adjusting excitation parameters, purification thresholds, and reinjection timing accordingly. Diagnostic feedback enables Ava to scale the number of excitation units and chambers in real time.

Predictive analytics further allow Ava to anticipate subsystem degradation, enabling proactive maintenance and extending system lifetime. The Ava Safety System provides predictive, layered protection across photonic, thermal, chemical, and electrical domains, including photonic alignment stabilization, thermal and pressure management, gas purity safeguards, radiation safety, predictive hazard modeling, fail-safe isolation, and backup power continuity.

The modular design supports scalability and serviceability. Optical assemblies, photonic materials, chamber housings, and safety sensors can be substituted or upgraded without requiring redesign of the entire system. Thermal recovery modules capture sensible and latent heat from one or more chambers and from purification stages, recycling energy for feedwater preheating, chamber stabilization, or coupling to external power cycles. The system can further integrate with external energy sources including solar, geothermal, hydroelectric, nuclear waste-heat recovery, and hydrogen-based backup. In certain optimized multi-chamber configurations, projected efficiencies of greater than 90% (LHV basis) are achievable, surpassing prior art benchmarks while reducing entropy losses.

By combining Floquet-engineered excitation, dielectric laser acceleration, catalyst-free water dissociation, AI-controlled purification and reinjection, predictive safety, and modular scalability, the present invention provides a hydrogen production platform that is more efficient, more adaptive, and more secure than prior systems. It establishes a foundation for both industrial hydrogen production and integration with next-generation energy platforms, setting a new threshold for yield, stability, and operational safety.

### BRIEF DESCRIPTION OF DRAWINGS

FIG. 1—System Architecture Block Diagram (with Safety Module)

FIG. 1 is a block diagram illustrating the hydrogen production system architecture. The system comprises a pre-filtration and desalination unit for water input (110), a nuclear or external heat exchanger (115) delivering heated feedwater, and a pre-filtration desalination unit for laser input (120). A laser chamber (130) incorporates a Floquet-polariton region (132) for bond destabilization. Multiple feedback sensor arrays (140, 142) acquire spectrothermal, photonic, and chemical data. A feedback controller (150), enabled by Ava's AI/quantum optimization engine, governs chamber excitation sequences and process timing. The system outputs purified hydrogen (160) and oxygen exhaust (170). A system-wide safety module (145) underpins all operations, integrating sensor feedback with predictive hazard modeling, emergency cutoff, and fail-safe continuity to ensure operational stability across all subsystems.

FIG. 2—Sequential Process Flow

FIG. 2 is a flow diagram illustrating the sequential hydrogen production process. A Stage 1 vibrational excitation module (210) is configured to apply pulsed laser energy to water molecules. A Stage 2 Floquet-engineered polariton interaction module (220) redistributes charge density to destabilize bonds. A Stage 3 laser gating module (230) provides controlled bond breakage, assisted by a feedback-controlled gating subsystem (240) for precision timing. A continuous dissociation stage (250) sustains hydrogen production.

FIG. 3—Vibrational Excitation Process Loop

FIG. 3 is a process flow diagram illustrating dissociation stages. An infrared, terahertz, mid-infrared, or femtosecond laser input module (310) drives a vibrational excitation stage (320). A polariton-induced destabilization stage (330) destabilizes O—H bonds, followed by a hydrogen dissociation stage (340). An AI-or quantum-controlled feedback module (350) continuously optimizes process parameters.

FIG. 4—Feedback Control Detail

FIG. 4 is a flow diagram illustrating the feedback control subsystem. A sensor module (410) acquires spectroscopy and diagnostic data. An Ava controller (420) executes adaptive gating algorithms. A high-speed laser gating module (430) regulates pulse delivery, and a precisely timed laser pulse generator (440) provides controlled off-gating at femtosecond-to-picosecond resolution.

FIG. 5—Laser and Polariton Sequence

FIG. 5 is a schematic diagram illustrating the sequential dissociation process. A laser source (510) delivers excitation through a gating module (520) into a vibrational excitation region (530). An O—H bond representation (540) indicates targeted vibrational modes. An AI and quantum controller (550) governs excitation in coordination with a proton polariton module (560). A hydrogen output interface (570) delivers purified hydrogen products.

FIG. 6—Staged Hydrogen Production Cycle

FIG. 6 is a process diagram illustrating a four-stage hydrogen production cycle. Stage 1 vibrational excitation via laser pulsing (610) is followed by Stage 2 Floquet-engineered polariton interaction (620). Stage 3 laser gating (630) occurs at the precise moment of dissociation. Stage 4 continuous cycling (640) sustains hydrogen generation with minimal energy input.

FIG. 7—Regenerative Closed-Loop Integration

FIG. 7 is a schematic diagram illustrating regenerative closed-loop operation. A dissociation chamber (710) receives laser pulse input (720) and vibrational excitation input (730). Separate oxygen (740) and hydrogen (750) outputs are provided. Reinjected purified water and oxygen (760) flow into AI-monitored valves and a thermal recovery module (770), which couples with a regeneration module (780) for closed-loop operation.

FIG. 8—Integrated Multi-Chamber Architecture

FIG. 8 is a schematic block diagram illustrating the integrated hydrogen production system overview. A safety module (805) forms the governing protective layer across all operations. An Ava quantum AI controller (899) operates as the central platform for control and optimization, receiving continuous input from feedwater input (810), laser excitation sources (820), and external heat inputs (830). Chamber 1 (840) initiates dissociation, Chamber 2 (850) completes dissociation of under-processed fractions, and Chamber 3 (860) performs purification and reinjection. Purified hydrogen is compressed and stored (870/895), oxygen output (880) and water vapor (890) are either vented or reinjected, and purified hydrogen may also drive a backup hydrogen-powered generator (896). A thermal recovery module (898) captures heat across chambers and outputs for feedwater preheating, chamber stabilization, or coupling to external energy cycles.

FIG. 9—Lens Assembly with Active Cooling

FIG. 9 is a schematic diagram illustrating a lens assembly with active cooling, under Ava-governed safety control. A safety module (905) and Ava quantum AI controller (907) oversee system operations, ensuring chamber-level stability. A lens housing (910) supports a high-durability optical lens (920), which may be fabricated from sapphire, diamond, or graded-index materials to withstand high-intensity excitation. Active cooling channels (930) circulate inert gases to dissipate heat, supported by a thermally conductive heat sink (940). A lens input beam (950) enters the system and exits as an output focus beam (960) following controlled refraction through the cooled optical assembly. Inert cooling gas inlet and outlet maintain flow for stable thermal regulation. Ava continuously monitors alignment, temperature, and pressure through embedded safety features, adjusting laser pulse parameters and cooling flow in real time. This prevents beam misalignment, optical fracture, or thermal runaway, ensuring continuous, fail-safe operation within the modular architecture.

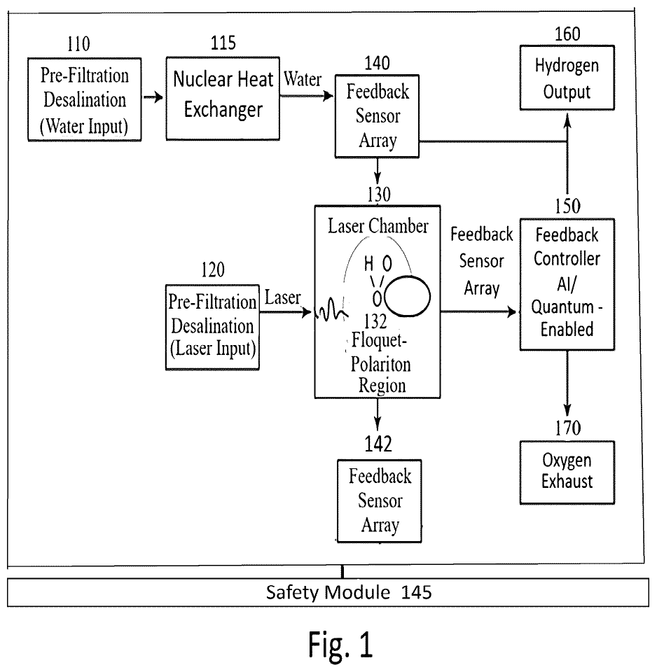

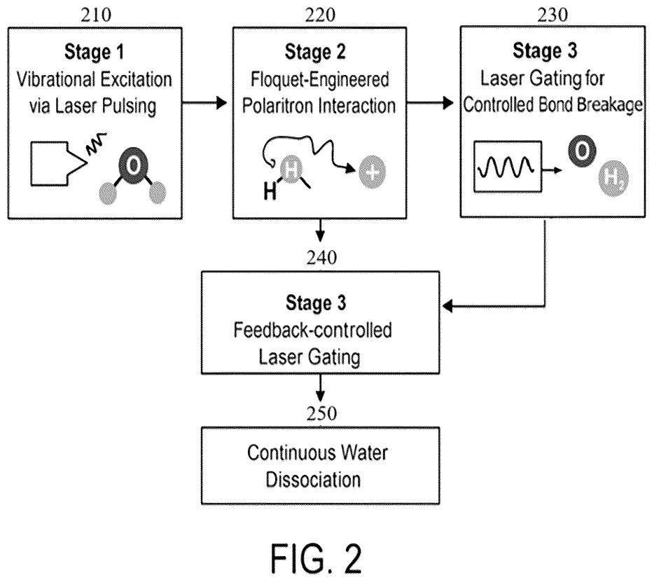

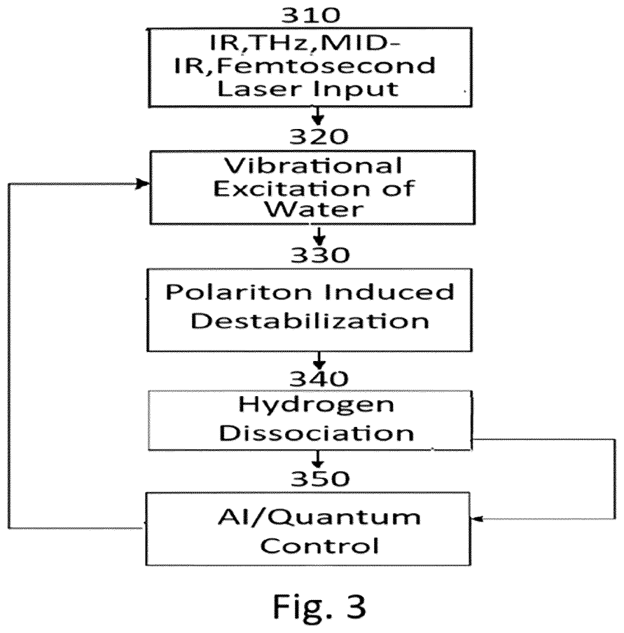

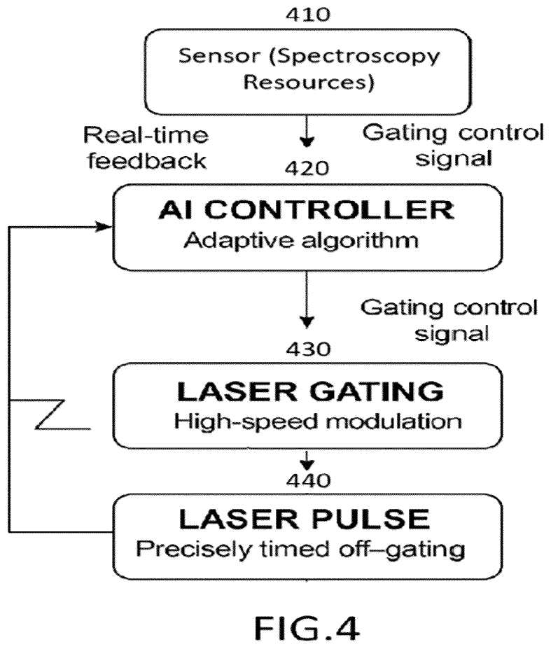

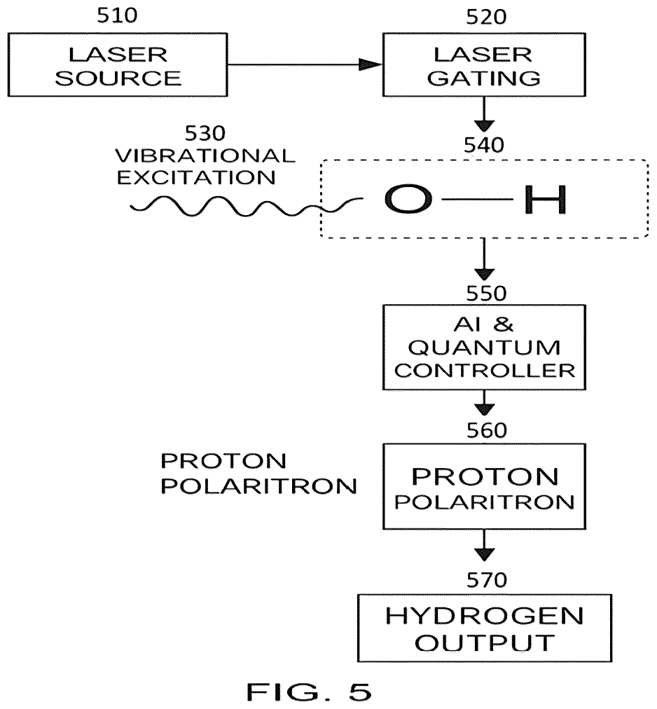

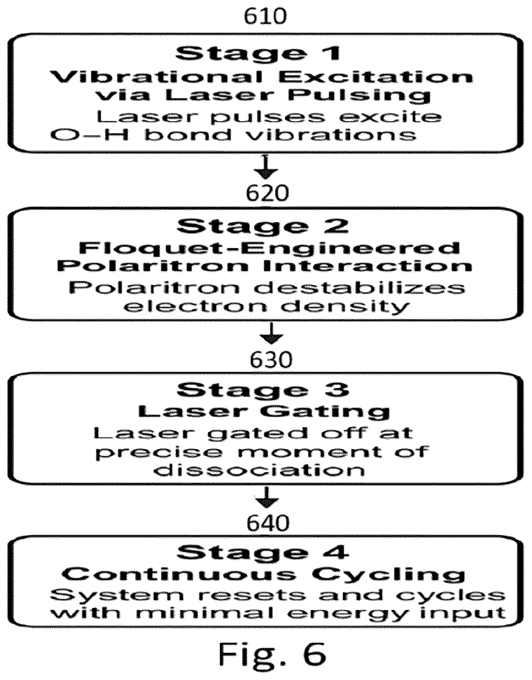

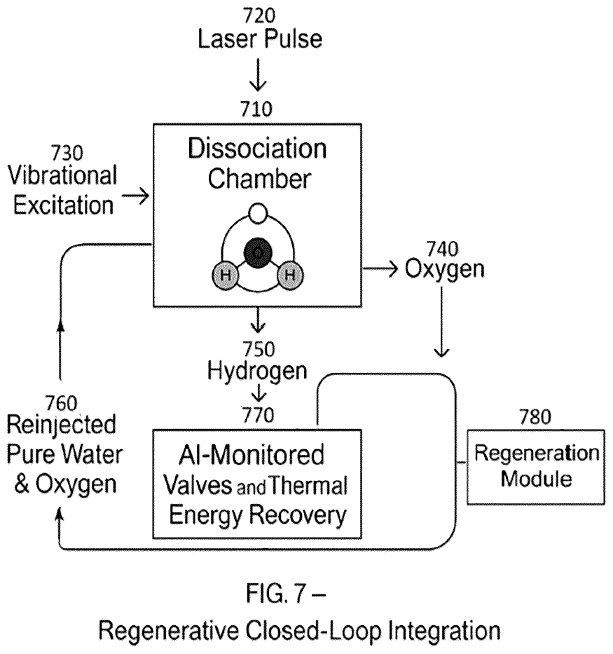

### SYSTEM OVERVIEW

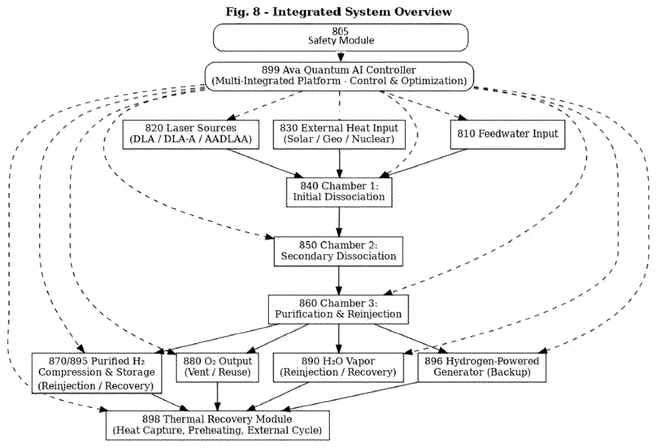

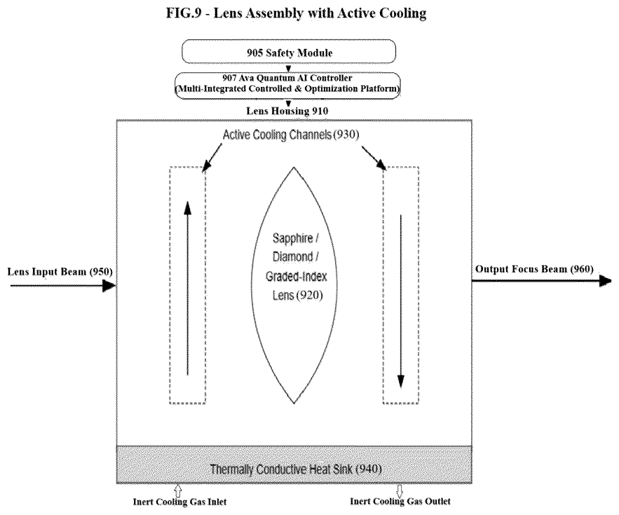

As illustrated in FIG. 8, the invention may be embodied as a fully integrated hydrogen production system in which all previously described subsystems are arranged in functional unison under the direction of the Ava quantum AI controller. The integrated architecture includes three or more excitation chambers configured for sequential or parallel operation, purification and reinjection subsystems, a thermal energy recovery module, and safety oversight distributed across photonic, thermal, chemical, and electrical domains.

A first dissociation chamber receives filtered feedwater and is driven by at least one dielectric laser excitation unit, which may include a dielectric laser accelerator (DLA), dielectric laser amplifier (DLA-A), or an Ava-assisted dielectric laser amplifier accelerator (AADLAA). Floquet-engineered photonic excitation is applied to destabilize O—H bonds and initiate bond stretching.

A second dissociation chamber is configured to receive partially dissociated effluent from the first chamber, continuing excitation under Ava's diagnostic guidance to complete dissociation of under-processed fractions. Ava dynamically determines which fractions are transferred forward, which are recirculated, and which are diverted to purification.

A third purification and reinjection chamber is configured to purify recovered hydrogen, oxygen, and water vapor. Purified hydrogen may be compressed and routed to storage or distribution, while oxygen and water vapor may be reinjected under AI-controlled gating to stabilize thermodynamics or serve as kinetic buffers. Ava orchestrates reinjection such that only those fractions improving dissociation kinetics, yield, or purity are cycled back into one or more chambers.

A thermal recovery module is coupled across the chambers and purification stage. This subsystem captures both sensible and latent heat and routes it toward feedwater preheating, chamber stabilization, or coupling into an external energy cycle (e.g., Rankine or Brayton). In certain embodiments, external heat inputs—including solar thermal, geothermal, hydroelectric, or nuclear waste-heat recovery—may be coupled into the module for hybrid operation.

Throughout the integrated system, the Ava AI/quantum controller functions as the core optimization engine. Ava receives continuous diagnostic signals from spectrothermal sensors, photonic detectors, and chemical feedback arrays, and adapts laser pulse parameters, excitation sequencing, reinjection gating, and subsystem diagnostics in real time. The modular nature of the design allows new excitation technologies, sensor arrays, or purification modules to be added or replaced without redesigning the entire system.

In combination, the integrated configuration illustrated in FIG. 8 provides a complete system-level embodiment wherein each subsystem-dissociation, purification, reinjection, thermal recovery, and AI-driven safety-operates in concert to maximize hydrogen yield, purity, and overall efficiency while maintaining predictive safety and serviceability.

### Closing Statement

In view of the foregoing, the present invention provides a hydrogen production system that achieves catalyst-free water dissociation with superior efficiency, modular adaptability, and integrated safety. Through Ava's unified quantum AI governance, the system dynamically optimizes excitation, purification, reinjection, compression, and thermal recovery, while maintaining predictive hazard protection across photonic, thermal, and chemical domains. The disclosed embodiments enable a platform that is not only efficient and upgradeable, but also inherently failsafe, supporting long-term scalability and adaptability to emerging energy technologies.

1. System Claim hydrogen production system comprising:
(a) one or more Floquet-engineered photonic excitation modules configured to excite O—H vibrational modes and destabilize molecular bonds;
(b) a dielectric-laser excitation unit including one or more of a dielectric laser accelerator, a dielectric laser amplifier, or an Ava-assisted dielectric laser amplifier-accelerator (AADLAA);
(c) an optical subsystem configured to deliver excitation into a dissociation chamber, the optical subsystem comprising a lens assembly and one or more of: mirrors, beam splitters, gradient-index (GRIN) optical elements, and electrically tunable reflective elements selected from MEMS deformable mirrors, liquid-crystal modulators, electro-optic dielectric stacks, or metamaterial/graphene-based reflectors;
(d) a dissociation chamber operably coupled to the excitation sources and the optical subsystem;
(e) an Ava quantum AI controller comprising one or more processors configured to (i) maintain phase synchronization and frequency matching of excitation to an O—H vibrational mode, (ii) dynamically adjust excitation timing and switch between frequencies across Floquet and dielectric excitation sources and adjust optical path length and alignment via the optical subsystem such that pulses coincide with the outer turning point of O—H bond stretching or perform selective purification or reinjection stabilization reinjection stabilization tasks, and (iii) continuously receive spectrothermal, pressure, and gas-composition sensor data to govern duty cycle, gating, and chamber routing; and
(f) a closed-loop reinjection cycle configured to return purified fractions meeting predetermined purity and temperature thresholds, wherein reinjection timing is selectively gated by Ava to stabilize thermal balance and enhance bond-destabilization kinetics.

2. The system of claim 1, further comprising a purification subsystem configured to purify hydrogen, oxygen, and water vapor prior to reinjection, the purification subsystem comprising at least one of: a dielectric laser accelerator (DLA), a dielectric laser amplifier (DLAa), an Ava-assisted dielectric laser amplifier-accelerator (AADLAA), membrane separation, pressure-swing adsorption, cryogenic distillation, electrochemical separation, or catalytic recombination.

3. The system of claim 2, wherein the purification subsystem comprises at least one of a Floquet-engineered photonic excitation module and an Ava-controlled dielectric laser amplifier-accelerator (AADLAA), the AADLAA being further configured to photodissociate residual fractions, stabilize purity of hydrogen, water, oxygen, and isotopic water species including deuterated water (D₂O) and tritiated water (HTO), and selectively route purified fractions into compression or reinjection cycles under Ava control.

4. The system of claim 1, wherein reinjection is governed by Ava through AI-controlled selective gating, such that only fractions that improve purity, stabilize thermal balance, or enhance bond destabilization kinetics are returned to the cycle.

5. The system of claim 1, wherein the dielectric-laser excitation unit comprises an Ava-assisted dielectric laser amplifier-accelerator (AADLAA) configured to both amplify and accelerate an optical field and deliver phase-synchronized, sub-cycle excitation to an O—H vibrational mode under closed-loop tuning by Ava, wherein the amplifier comprises multilayer dielectric (MLD) gratings configured to provide high-damage-threshold, ultrafast pulse compression and to generate ultra-intense, ultrashort laser pulses for high-intensity operation under Ava control.

6. Method Claim A method of producing hydrogen comprising:
(a) exciting water molecules at vibrational resonances using one or more excitation sources selected from: a Floquet-engineered photonic excitation module, a dielectric laser accelerator (DLA), a dielectric laser amplifier (DLAa), or an Ava-assisted dielectric laser amplifier-accelerator (AADLAA);
(b) applying said excitation in a dissociation chamber to stretch O—H vibrational bonds toward destabilization;
(c) transferring un-dissociated water molecules, including isotopologues such as H₂O, D₂O, or HTO, wherein certain isotopologues, including HTO, provide localized radiogenic heating that enhances vibrational bond stretching and facilitates dissociation under Floquet and or a combination of dielectric laser accelerators, amplifiers and excitation modules, into a subsequent dissociation chamber equipped with the same excitation sources to continue bond stretching until dissociation is achieved, wherein Ava subsystems and safety modules further direct any isotopic hydrogen fractions produced, including tritium, into a secure containment or storage subsystem as part of the system's safety process;
(d) under Ava control, dynamically switching excitation timing between different frequencies of Floquet and dielectric excitation sources so that pulses coincide with the outer turning point of O—H vibrational stretching or perform purification or reinjection stabilization tasks;
(e) dissociating hydrogen and oxygen in the reaction chamber;
(f) purifying recovered hydrogen, oxygen, and water vapor; and
(g) selectively reinjecting purified fractions into the reaction chamber under Ava-controlled gating to stabilize thermodynamic balance and enhance dissociation kinetics.

7. The method of claim 6, wherein purification is performed prior to reinjection, and wherein compression of purified hydrogen ensures safe storage and distribution, and wherein reinjection is directed into one or more chambers of the dissociation cycle, including the primary dissociation chamber and the secondary chamber for under-processed fractions, under Ava control, thereby maintaining operational stability and safety.

8. The method of claim 6, further comprising allocating purified hydrogen either to (i) reinjection cycles for kinetic buffering or (ii) a generator module for backup power, wherein Ava controls allocation to maintain operational stability and efficiency.

9. The method of claim 6, wherein the thermal recovery module captures sensible and latent heat from the dissociation and purification chambers, and wherein thermal management further comprises active cooling of optical lens assemblies with helium or argon gas and associated heat sinks, using said heat for feedwater preheating and external cycle coupling.

10. Modular Platform Claim A modular hydrogen production platform comprising:
(a) a plurality of excitation chambers arranged in series or parallel, each configured with at least one dielectric laser excitation unit and at least one Floquet-engineered photonic excitation module, wherein the units operate in unison under control of the Ava quantum AI controller;
(b) a centralized Ava quantum AI controller operably coupled to each chamber, configured to adaptively govern excitation sequences, reinjection cycles, purification, compression, and safety across the platform;
(c) purification and compression subsystems for recovered hydrogen, oxygen, and water vapor;
(d) an adaptive reinjection cycle configured to return only purified fractions that improve yield, purity, or stability;
(e) a thermal recovery module configured to capture sensible and latent heat from the dissociation and purification chambers; and
(f) a backup generator module configured to receive purified hydrogen under Ava allocation, providing auxiliary or emergency power while ensuring continuous safe operation.

11. The modular platform of claim 10, wherein Ava further governs predictive hardware diagnostics to recommend activation, deactivation, or addition of dielectric excitation units to maintain optimal bond destabilization and yield efficiency.

12. The modular platform of claim 10, wherein Ava functions as the core optimization engine, unifying excitation control, safety oversight, purification, compression, reinjection, and backup generation into a single adaptive safety frame.

13. The system of claim 1, wherein the AI controller comprises a quantum machine learning module configured to outperform classical models in system diagnostics, dissociation optimization, and predictive safety.

14. The system of claim 1, wherein the AI controller refines quantum control sequences in real time to optimize thermal cycling, gas separation, and energy balancing.

15. The system of claim 1, wherein Ava provides predictive hazard modeling across photonic, thermal, chemical, and electrical domains, including continuous monitoring of optical lens assemblies, sapphire or diamond optics, and helium-or argon-based cooling systems, and governs fail-safe isolation and backup power continuity.

16. The system of claim 1, wherein the modular architecture enables integration with external energy sources including solar, hydroelectric, geothermal, nuclear waste-heat recovery, hydrogen-based backup, and hybrid renewable inputs, and wherein the excitation system further comprises sapphire, diamond, or gradient-index (GRIN) optical lens assemblies for shaping excitation fields.

17. The system of claim 1, wherein the architecture permits serviceability, replacement, and upgrade of optical assemblies, photonic components, chamber housings, and safety sensors without redesigning the entire system.

18. The modular platform of claim 10, wherein the multi-chamber arrangement comprises: a first dissociation chamber, a second dissociation chamber for under-processed fractions, and a third purification/reinjection chamber configured to receive un-dissociated water molecules including isotopologues such as H₂O, D₂O, or HTO together with residual fractions, to return purified hydrogen under Ava-directed routing, and to direct isotopic hydrogen fractions, including tritium, into a secure containment subsystem as part of the system's safety and storage process.

19. The modular platform of claim 10, wherein purified hydrogen is selectively reinjected into one or more chambers as a kinetic buffer to stabilize dissociation dynamics and enhance safety control.

20. The system of claim 1, wherein the optical assemblies comprise one or more of: mirrors, beam splitters, gradient-index (GRIN) optical elements, and electrically tunable reflective elements selected from MEMS deformable mirrors, liquid-crystal modulators, electro-optic dielectric stacks, or metamaterial/graphene-based reflectors, all governed by Ava to align, redirect, or synchronize excitation pulses between Floquet and dielectric excitation sources to achieve phase-coherent timing at the outer turning point of O—H vibrational stretching or for selective purification and reinjection stabilization tasks.
